(19) United States
(12) Patent Application Publication
(10) Pub. No.: US 2024/0330614 A1
(43) Pub. Date: Oct. 3, 2024

(54) SELF-INTERFERENCE CANCELLATION FOR RFID TAG READERS

(71) Applicants: Joe MUELLER, San Diego, CA (US); Adam BLAIR, San Diego, CA (US); Jeff GOOS, San Diego, CA (US); Automaton, Inc., San Diego, CA (US)

(72) Inventors: Joe Mueller, San Diego, CA (US); Adam Blair, San Diego, CA (US); Jeff Goos, San Diego, CA (US)

(73) Assignee: Automaton, Inc., San Diego, CA (US)

(21) Appl. No.: 18/574,811

(22) PCT Filed: Jun. 30, 2022
(86) PCT No.: PCT/US2022/035646

§ 371 Date: Dec. 28, 2023

Related U.S. Application Data
(60) Provisional application No. 63/217,218, filed on Jun. 30, 2021.

(51) Int. Cl. G06K 7/10; H04B 1/00

(52) U.S. Cl. CPC G06K 7/10019; H04B 1/0003

(57) ABSTRACT

A radio-frequency identification (RFID) tag reader interrogates a passive RFID tag by transmitting a signal to the tag, then detecting a much weaker reply at the same carrier frequency from the tag. Unfortunately, self-interference caused by signal leakage within the reader or crosstalk among the reader's antenna elements can make the reply more difficult to detect and limit the range at which the reader can sense tags. A self-interference cancellation circuit in the reader reduces or suppresses the effects of signal leakage and crosstalk, enabling detection of weaker tag replies. The self-interference cancellation circuit can calibrate itself before each transmission to ensure good performance. This improves the reader's sensitivity, increases the reader's range, reduces the reader's power consumption, and/or reduces the minimum required dynamic range of the analog-to-digital converters (ADCs) that digitize the received tag replies.

### CROSS-REFERENCE TO RELATED APPLICATION(S)

This application claims the priority benefit, under 35 U.S.C. 119 (e), of U.S. Application No. 63/217,218, filed on Jun. 30, 2021, which is incorporated herein by reference in its entirety.

### BACKGROUND

A radio-frequency identification (RFID) tag reader, also called an RFID tag interrogator, reader, or sensor, is a device that communicates with RFID tags. A passive RFID tag is powered by the signal transmitted by the reader. A reader interrogates a passive tag by transmitting an unmodulated, continuous-wave (CW) radio-frequency (RF) signal to the passive tag. This RF signal powers the passive RFID tag's circuitry. Once the circuitry is powered on, the passive RFID tag can receive and process a modulated RF signal with a command or query from the reader. The passive RFID tag responds to the command or query by modulating and re-radiating the RF signal from the reader back to the reader. This entire sequence of charging a passive RFID tag, commanding or interrogating the passive RFID tag, and receiving the passive RFID tag's response is called a hop.

The maximum distance or range between the antenna(s) of a reader and a passive RFID tag depends on the maximum power of the RF signal transmitted by the reader toward the RFID tag, the minimum turn-on power or sensitivity of the RFID tag, the maximum power of the tag's reply, the loss in the communications channel between the reader and the RFID tag, noise, interference, and the sensitivity of the reader. The maximum power of the RF signal from the reader is usually limited by a government regulatory body to prevent interference with other wireless devices. In the United States, the Federal Communications Commission (FCC) limits the maximum power of RF signals transmitted by RFID tag readers to about 30 dBm (1 W). A passive RFID tag typically reflects or back-scatters about 10% of the incident power in the RF signal from the reader as its reply. This efficiency translates to a loss of about 10 dB. If round-trip channel loss is 80 dB due to scattering, reflections, and/or attenuation, then the signal power reaching the reader is about −60 dBm (1 nW). Neglecting noise and interference, if the reader's sensitivity is −70 dBm and the desired signal-to-noise ratio (SNR) is 10 dB, then the reader should be able to detect and decode the RFID tag's reply.

The round-trip channel loss generally increases with range, so increasing the reader's range generally involves some combination of increasing the transmitted signal power, increasing the tag back-scattering efficiency and sensitivity, reducing noise and interference, and improving the reader sensitivity. Unfortunately, the FCC limits the maximum signal power transmitted to the tag (and hence the amount of power available for the tag's reply) and thermal noise fundamentally limits the reader sensitivity. With some conventional systems, FCC regulations on maximum transmitted power and path loss limit the maximum achievable range from a reader to a passive RFID tag to about 15 meters.

Self-interference or transmitter leakage also limits the range. Self-interference occurs when a portion of the transmission from the reader overlaps in time with the tag's response and is detected by the receiver, e.g., through a path within the reader or from local reflections. This unwanted signal can obscure the tag's response and generate additional noise at the receiver. Unfortunately, the self-interference cannot be filtered away because it is at the same frequency as the tag's response. During a hop (transmission and response cycle), the reader transmits continuously to power the tag, so the tag's response always overlaps with the reader's transmission. As a result, self-interference affects every hop. In addition, in a reader with multiple antenna elements that transmit and receive simultaneously, the transmission from each antenna element can leak into the receive streams collected by the other antenna elements via crosstalk between antenna elements and local reflections.

### SUMMARY

Self-interference cancellation of the transmission from the reader typically involves canceling the leakage signal and local reflections and compensating for harmonics and noise generated by nonlinearities in the amplifiers, mixers, and other transmitter components. The range of an RFID system can be increased by improving the self-interference cancellation and by using RFID tag readers that can optionally be switched between interrogator and listener modes. Improving self-interference cancellation reduces the dynamic range of the signal coupled to the analog-to-digital converter(s) (ADC(s)) in the receiver portion of the reader. This reduces the ADC dynamic range requirement, which reduces cost, and/or reduces the tag-reply-to-quantization noise ratio as the tag reply consumes a greater portion of the ADC's dynamic range.

When interrogating an RFID tag (e.g., in optional interrogator mode), a reader transmits commands or queries and receives RFID tag replies. The transmitted signal leaks through the circulator in the reader's front end and reflects off the antenna and physical environment to create a loopback signal that may drown out any tag replies. The reader has an analog self-interference cancellation circuit that subtracts the reflected transmitted signal from the received signal, making it easier to detect the potentially much weaker tag reply. It can calibrate the complex gain of the self-cancellation circuit before each transmission to compensate for temperature and age variations in the receiver and to account for slow variations in the channel to the RFID tag (i.e., pseudo-stationary of a hop duration). In (optional) listener mode, the reader does not transmit any commands or queries; instead, it listens for commands and queries from other readers and for the tag responses to those commands and queries. Because the reader does not transmit a signal in listener mode, it does not have any leakage or associated noise to cancel and so can potentially detect weaker responses (e.g., from tags that are farther away/at longer ranges).

An example RFID tag reader can include a signal generator, antenna array, three-port circulator, self-interference cancellation circuit, and processor. In operation, the signal generator generates an interrogation signal. The antenna array transmits this interrogation signal to an RFID tag and receives a reply to the interrogation signal from the RFID tag. The circulator's first port is operably coupled to the signal generator and receives the interrogation signal, its second port is operably coupled to the antenna array and couples the interrogation signal to the antenna array and receives the reply from the antenna array, and its third port emits the reply to the interrogation signal. The self-interference cancellation circuit is operably coupled to the signal generator and the third port of the circulator. It cancels interference caused by (i) leakage of the interrogation signal from the first port of the circulator to the third port of the circulator and/or (ii) crosstalk between antenna elements in the antenna array. And the processor, which is operably coupled to the self-interference cancellation circuit, calibrates a complex (cancellation) gain of the self-interference circuit.

To calibrate the complex gain, the self-interference cancellation circuit can perform measurements y₁(n) and y₂(n) of self-interference cancellation at first and second complex gain settings G_{X}(n) and G_{X}(n)G_{Δ}, respectively. The processor adjusts the complex gain based on the measurement y₁(n), the first complex gain setting G_{X}(n), the measurement y₂(n), and the second complex gain setting G_{X}(n)G_{Δ}. In this case, the processor may include an integrator and one or two Coordinate Rotation Digital Computers (CORDICs) that are operably coupled to the integrator to calibrate the complex gain. An integrator in the self-interference cancellation circuit can perform the measurements y₁(n) and y₂(n). For instance, the integrator can perform the measurements y₁(n) and y₂(n) by acquiring a number of cycles equal to an integer multiple of a number of cycles of carrier frequency of the interrogation signal. At the same time, the number of cycles can also be equal to an integer multiple of a number of cycles of a carrier frequency of a channel adjacent to a channel of the interrogation signal. The CORDIC(s) computes a magnitude and a phase of y₂(n)G_{Δ}−y₁(n) and a magnitude and a phase of the difference between the measurements y₂(n)−y₁(n).

The self-interference circuit may include an adjustable phase compensator, first and second digital-to-analog converters (DACs), and an adjustable gain compensator. The adjustable phase and gain compensator provide phase and gain components, respectively, of the complex gain. The first DAC is operably coupled to the adjustable phase compensator and the processor and adjusts the phase component of the complex gain based on feedback from the processor. The second DAC is operably coupled to the adjustable gain compensator and the processor and adjusts the gain component of the complex gain based on feedback from the processor.

The RFID tag reader can be switched between an interrogator mode in which the RFID tag reader transmits interrogation signals and receives replies to the interrogation signals and a listener mode in which the RFID tag reader receives interrogation signals from other RFID tag readers and replies from the RFID tags to the interrogation signals from the other RFID tag readers. The self-interference cancellation circuit can be disabled when the RFID tag reader is in listener mode.

An RFID tag reader can interrogate an RFID tag as follows. First, the RFID tag reader generates a continuous wave (CW) signal. It calibrates a complex cancellation gain of the self-interference cancellation circuit based on iterative measurements of self-interference cancellation of the CW signal at a first receiver gain level. After the complex cancellation gain has been calibrated, the RFID tag reader transmits an interrogation signal to the RFID tag and receives a reply to the interrogation signal from the RFID tag at a second receiver gain level higher than the first receiver gain level. It cancels self-interference from the reply with the self-interference cancellation circuit.

An RFID tag reader can be calibrated by performing first and second measurements of self-interference cancellation by a self-interference cancellation circuit of the RFID tag reader at first and second complex gains, respectively, of the self-interference cancellation circuit. A complex gain of the self-interference cancellation circuit can be adjusted based on the first measurement, the first complex gain, the second measurement, and the second complex gain. Performing the first measurement may include selecting the first complex gain (and the receiver gain applied to the tag reply after self-interference cancellation) based on a dynamic range of an analog-to-digital converter (ADC) of the RFID tag reader. The second complex gain can be greater than the first complex gain.

After the complex gain has been adjusted, the RFID tag reader can interrogate an RFID tag, e.g., by transmitting a continuous-wave (CW) signal to the RFID tag. While transmitting the CW signal, the RFID tag reader re-calibrates the complex gain of the self-interference cancellation circuit, e.g., by performing a pair of measurements of self-interference cancellation by the self-interference cancellation circuit and adjusting the complex gain based on the pair of measurements. Performing the pair of measurements comprises may include suppressing interference from channels adjacent to a channel of the signal transmitted by the RFID tag reader to the RFID tag. After re-calibrating the complex gain, the RFID tag reader transmits a signal to RFID tag and receives a reply to the signal. The RFID tag reader also cancels self-interference from the reply with the self-interference cancellation circuit.

All combinations of the foregoing concepts and additional concepts discussed in greater detail below (provided such concepts are not mutually inconsistent) are contemplated as being part of the inventive subject matter disclosed herein. All combinations of claimed subject matter appearing at the end of this disclosure are contemplated as being part of the inventive subject matter disclosed herein. The terminology explicitly employed herein that also may appear in any disclosure incorporated by reference should be accorded a meaning most consistent with the concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A shows an RFID tag location system with a central controller coupled to a set of RFID tag sensors, each of which can be switched between interrogator and listener modes, via an Ethernet local area network (LAN).

FIG. 1B illustrate how sensors in interrogator and listener modes can trigger and detect replies from a passive RFID tag.

FIG. 1C illustrates angle-of-arrival (AOA) measurements made with one sensor in interrogator mode and other sensors in listener mode.

FIG. 2 shows an RFID tag sensor that can be switched between interrogator and listener modes.

FIG. 3A shows a self-interference cancellation circuit suitable for use in an analog front end of an RFID tag sensor of FIG. 2.

FIG. 3B shows a model of the self-cancellation circuit of FIG. 3A.

FIG. 4 is a block diagram of processing logic used to calibrate the complex (cancellation) gain in a self-interference cancellation circuit.

FIG. 5A is a plot of the response of the digital-to-analog converter (DAC) that scales the gain component of the complex cancellation gain in a self-interference cancellation circuit.

FIG. 5B is a plot of the response of the DAC that scales the phase component of the complex cancellation gain in a self-interference cancellation circuit.

FIG. 6A is a timing diagram illustrating calibration of the self-interference cancellation circuit at the beginning of a hop for a reader in interrogator mode.

FIG. 6B is a timing diagram illustrating frequency estimation and tracking at the beginning of a hop for a reader in listener mode.

### DETAILED DESCRIPTION

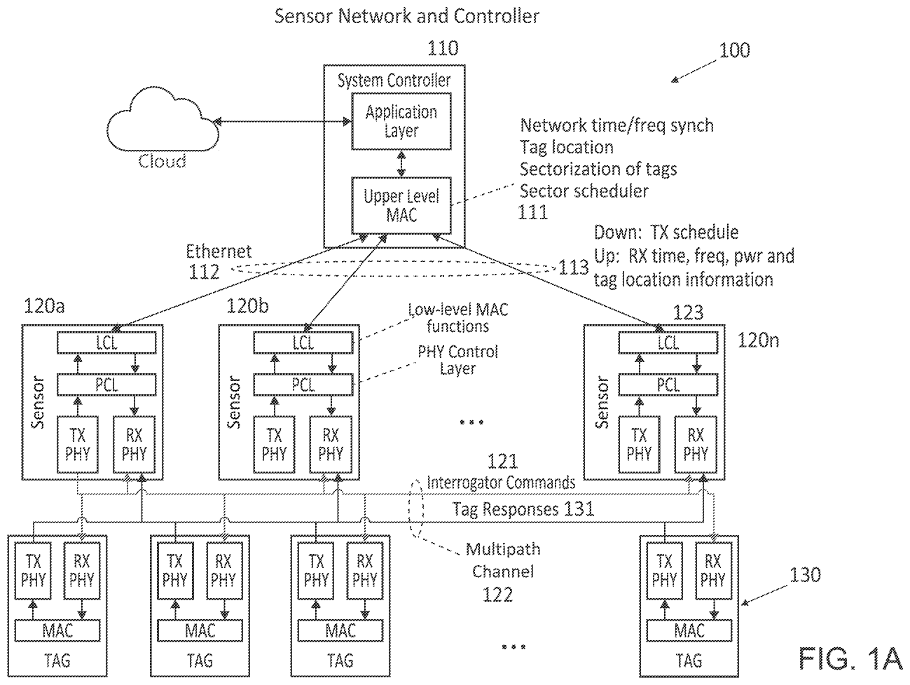

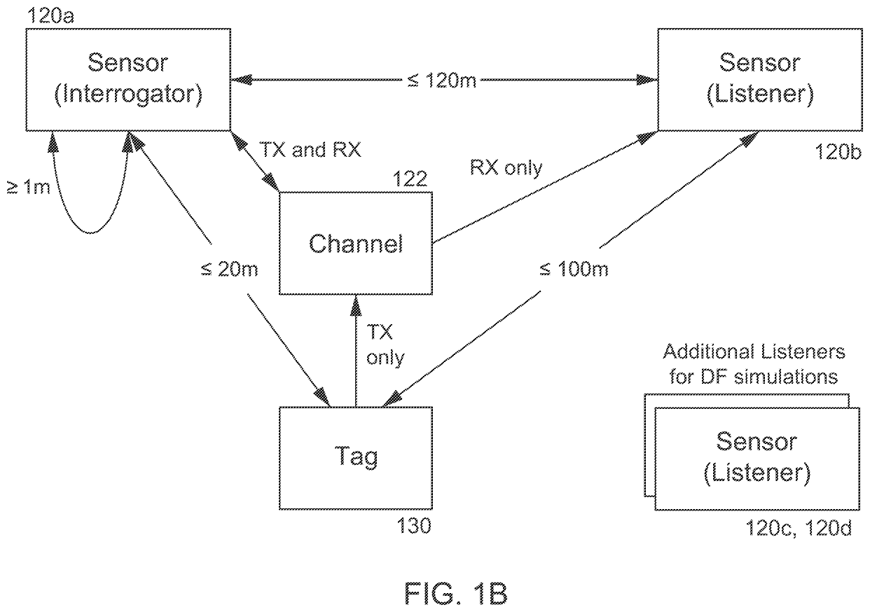

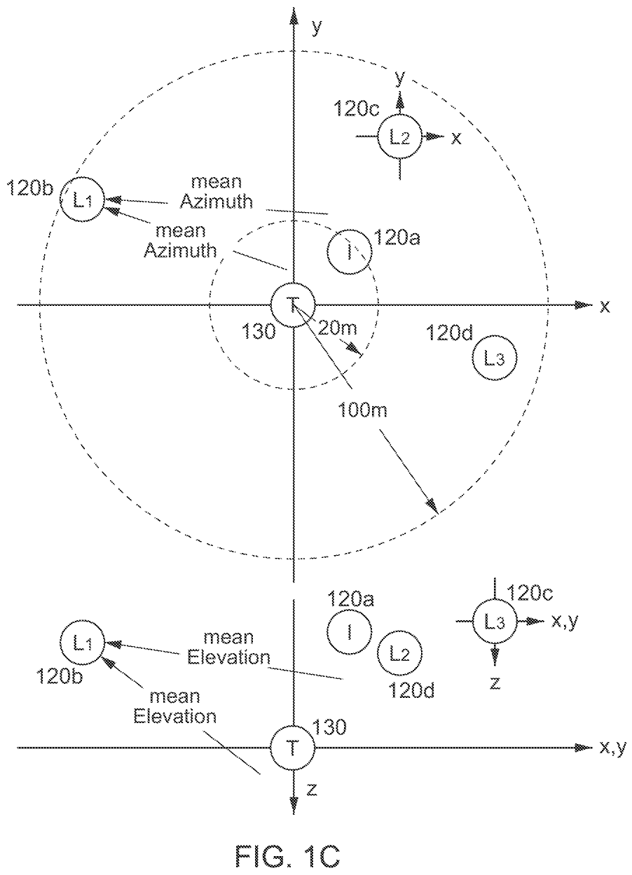

FIGS. 1A-1C illustrate an RFID tag location system 100 that locates one or more RFID tags 130 with several RFID tag readers 120a-120d (collectively, readers 120). Each reader 120 includes an analog front end, described in detail below, that can perform self-interference cancellation. This self-interference cancellation increases a reader's range by reducing the noise and increasing the dynamic range of the reader's receiver for reading an RFID tag 130 at a given range. If each reader 120 can detect RFID tags 130 that are farther away (e.g., at ranges of 10 meters instead of 5 meters), then the readers 120 can be spaced farther apart from each other and/or transmit signals to the RFID tag 130 at lower power levels. This reduces the number of readers 120 needed to locate and monitor RFID tags 130 in a given space. It can also reduce the amount of power consumed, in aggregate, by the readers 120.

Each reader 120 in FIGS. 1A-1C can also be switched between an interrogator mode in which the reader 120 transmits interrogation signals and receives tag responses to those interrogation signals and a listener or receive-only mode in which the reader 120 receives both interrogation signals from other readers 120 and tag responses to those other interrogation signals but does not transmit interrogation signals. Typically, only one reader 120 is in interrogator mode at a time while the other readers 120 are in listener mode. The reader 120 that is in interrogator mode interrogates a tag 130, and it and the readers 120 in listener mode within range receive the tag's reply. For N readers 120, this means making up to N measurements of the tag's reply simultaneously even though only one reader 120 may be transmitting an interrogation message at a time. This N-fold increase in the number of simultaneous measurements can be used to increase the speed (e.g., by a factor of N), fidelity (e.g., by a factor of √N through incoherent averaging), or speed and fidelity of the RFID tag location performed by the system 100. The readers 120 may make more simultaneous measurements in a round-robin fashion, with each reader 120 serving as the interrogator in turn while the other readers 120 act as listeners, further increasing measurement speed and/or fidelity. Because the listeners are not powering the tags, and hence do not suffer from self-interference, etc., they can detect tag responses at much greater ranges, making it possible to make measurements from distances/locations that are simply not possible with conventional systems. For more details about interrogator and listener modes, please see International Application No. PCT/US2022/026198, which is incorporated herein by reference in its entirety for all purposes

The readers 120 are connected to a system controller 110 via respective Ethernet connections 112 or other suitable (e.g., wired or wireless) connections as shown in FIG. 1A. The Ethernet connections 112 may connect the readers 120 to each other as well. The system controller 110 has a clock synchronized to network time and uses that clock to synchronize the readers 120 via the Ethernet connections 112. The readers 120 should be synchronized well enough that when different readers 120 time stamp the received replies from the same tag 130 sent at the same time, the system controller 110 can group and process the detected replies together. The synchronization should also be good enough to prevent excessive guard time between hops (e.g., allowing a minimum inter-hop spacing of 1 millisecond).

This synchronization may reveal that the latency of one or more of the Ethernet connections 112 and/or the variation in latency among the Ethernet connections 112 exceeds the allotted window or guard time for an RFID tag 130 to respond to an interrogation signal or command 121 from a reader 120, making it impractical for the readers 120 to communicate with each other about scheduling via the wired connections 112. If these latencies are larger than the allotted tag reply window/guard time, then the readers 120 may simply detect the broadcast commands 121 instead of sensing separate signals about the commands 121 to each other via the wired connections 112. The readers 120 can also communicate with each other wirelessly (e.g., over the same RF channel used for communicating with the tags 130) using reader-specific commands instead of via the local area network provided by the Ethernet connections 112. For example, reader-specific commands can coordinate and control mobile readers (discussed below).

The system controller 110 also includes a processor that generates a schedule 113 for interrogating the RFID tags 130. The schedule lists the time(s) at which each reader 120 is supposed to be in interrogator mode and in listener mode. That is, the schedule 113 lists when each reader 120 is supposed to emit interrogation signals 121, including queries and other interrogator commands. The schedule 113 may also list windows when each reader 120 should expect to receive interrogation signals 121 from other readers 120 and tag replies prompted by those interrogation signals 121. The system controller 110 transmits this schedule 113 to the RFID tag readers 120 via the Ethernet connections 112. It stores the schedule 113 in a local memory coupled to the processor. The system controller 110 receives tag reply data 123, including receive time, frequency, power, and tag location information, from the RFID tag readers 120 and stores this data 123 in the memory for later processing.

The readers 120 broadcast interrogation signals 121 according to the schedule 113, with each reader 120 in either interrogator mode or listener mode. Again, one reader 120 is in interrogator mode at a time, with the other readers 120 in listener mode. When the reader 120 in interrogator mode broadcasts the interrogation signal 121, the tags 130 receive the interrogation signal 121 via a wireless, multipath channel 122 through the store, warehouse, factory, or other environment in which the system 100 is deployed. At least one of the tags 130 responds to the interrogation signal 121 with a tag reply 131 that arrives at the reader 120 in interrogation mode within a predefined time window after the interrogation signal 121. The entire interrogation/reply sequence is called a hop and is described in greater detail below. The readers 120 in listener mode detect the interrogation signal 121 and tag reply 131 over the same wireless, multipath channel 122. The tag reply 131 as detected by the different readers 120 can be used to locate the tag 130 faster and/or more precisely than is possible with conventional RFID tag location systems.

FIGS. 1B and 1C illustrate how the RFID tag system 100 can be used to make multiple angle-of-arrival (AOA), range, and/or multipath signature measurements of a single tag reply 131 at the same time for faster and/or more accurate tag location measurements. In this case, the readers 120 are arrayed on the ceiling of a room, such as a room in a retail store or warehouse. There may be tens to hundreds of readers 120 in the environment, with each reader 120 separated from its nearest neighbor by up 120 meters (e.g., by 5, 10, 15, 20, 25, 30, 40, 50, 60, 70, 80, 90, 100, 110, or 120 meters) and connected to the controller (not shown) via an Ethernet or other wired or wireless connection. The distance separating each pair of readers 120 may be based on the maximum range for powering a tag 130, e.g., if the maximum range for powering a tag 130 is 10 meters, then the readers 120 may be 20 meters apart from each other. In practice, the readers 120 may be spaced 5-10 m apart to provide diversity (i.e., to ensure even that if a tag 130 is poorly oriented or shadowed relative to one sensor 120, another sensor 120 can still read the tag 130). Each reader 120 is oriented so that its antenna(s) emits interrogation signals 121 largely toward the floor, with less RF energy propagating sideways.

In this example, reader 120a is in interrogator mode and readers 120b-120d are in listener mode. Reader 120a transmits an interrogation signal 121 via a free-space channel 122, which could include one or more reflections, to an RFID tag 130. Reader 120a should be close enough to the tag 130, which is passive, for the interrogation signal 121 to power or charge the tag 130 enough to produce a detectable reply 131. Given constraints on maximum power, channel loss, and tag backscattering efficiency, the distance between the RFID tag 130 and reader 120a without self-interference cancellation is about 20 meters or less (e.g., 15, 10, or 5 meters). Effective self-interference cancellation reduces the noise floor and reduces the required ADC dynamic range, extending the range from the reader 120a to the RFID tag 130 (e.g., by a factor of 2 for a 6 dB reduction in the noise floor).

The other readers 120b-120d can be farther away from the tag 130 (e.g., up to 25, 50, 75, or even 100 meters away) because they are not powering or charging the tag 130, so they do not suffer from self-interference/transmit signal leakage. As a result, they do not have to perform self-interference cancellation in order to detect the response 131. The maximum distance between the other readers 120b-120d and the tag 130 depends on the amplitude of the reply 131, the channel loss, and the sensitivity of the readers 120 and can be up to 500 meters with the right receiver, antenna, and path-loss conditions. (The amplitude of the tag reply response is generally 10 dB below its turn-on power, which is typically around −17 dBm (and decreasing over time as semiconductor power efficiencies increase). The channel loss is around 32 dB at 1 meter and increases by about 6 dB for every doubling of distance. The sensitivity of a reasonable RFID receiver is −80 dBm.) The readers 120 may be arrayed within the room so that every reader 120 should be able to detect replies from every tag 130 or so that not every reader 120 can detect replies from every tag 130, depending in part on the shape and size of the room.

The tag 130 may have a dipole antenna that radiates the reply 131 in a donut-shaped pattern. Because the readers 120 are at different locations with respect to the tag 130, this RF field impinges each reader 120 from a different azimuth and/or elevation as shown at top and bottom, respectively, of FIG. 1C. Each reader 120 can calculate the corresponding azimuth and elevation AOAs and transmit the calculated AOAs for each tag 130 to the controller 110. Each reader 120 can also calculate the range to each tag 130, e.g., based on a received signal strength indication (RSSI) or other measurement of the power of the received reply 131. Alternatively, or in addition, each reader 120 can determine a multipath profile or signature, which can be represented as a variation in received signal strength (amplitude or power level) as a function of AOA (spatial angle). The AOAs, ranges, and/or multipath profiles can also be calculated, estimated, or determined by the controller 110 based on the replies received by the readers 120.

The controller 110 may aggregate the AOAs, ranges, and/or multipath profiles from the different readers 120 and use them to estimate the tag's location, e.g., by trilateration or triangulation. Because a single interrogation signal 131 yields multiple simultaneous AOA, range, and/or multipath profile measurements by up to all of the readers 120 in the system 100, the controller 110 can derive or estimate the location of the RFID tag 130 after just one hop, unlike in conventional RFID systems, which may take many hops to locate a tag 130 in two or three dimensions. With more measurements, the controller can estimate the tag's location relative to the readers 120 more precisely. If the readers' locations are known, the controller 110 can use them to estimate the tag's absolute location as well.

Readers 120b-120d also detect the interrogation signal 121 from reader 120a before detecting the tag reply 131. When a reader 120 is in listener mode, it scans the relevant RFID communication band (e.g., 902 to 928 MHz in the United States or 865 to 868 MHz in Europe) for the interrogation signal 121, which may be broadcast on one of many channels (e.g., 20 or 50 channels) within that band. When a reader 120 in listener mode detects an interrogation signal 121 on a particular channel, it listens for a reply 131 on the same channel within a predetermined or preset time window of the end of the interrogation signal 121. After the time window closes, the reader 120 can resume scanning channels for interrogation signals or enter interrogator mode. The reader 120 may also demodulate or decode the interrogation signal 121 and use the decoded interrogation signal 121 to interpret the reply 131 from the tag 130.

The interrogation signal 121 tells the tag 130 how to respond (i.e., the modulation, preamble-type, and bit rate for the reply 123). The readers 120 in listener mode listen for the commands 121 to know how the tag 130 should respond to the command 121. The readers 120 in listener mode also determine the end-time of the command 121 to know when to expect the tag reply 123 based on the timing constraints placed on the tag's reply 123, e.g., by the EPC™ Radio-Frequency Identity Protocols Generation-2 UHF RFID Standard: Specification for RFID Air Interface Protocol for Communications at 860 MHz-960 MHz, Version 2.0.0, which is incorporated herein by reference in its entirety.

If the readers 120 are mounted on the ceiling and broadcast interrogation signals 131 downward (toward tags 130), they may detect the interrogation signals 131 from other readers 120 via non-line-of-sight (NLOS) paths. In FIGS. 1B and 1C, for example, reader 120a emits the interrogation signal 131 downward, causing at least a portion of the signal 131 to reflect or scatter off the floor, shelving, and/or other objects. The other readers 120b-120d detected this reflected or scattered energy, possibly instead of or in addition to detecting energy that propagates directly from reader 120a without scattering or reflecting off another surface. Even accounting for attenuation along the NLOS path, the detected interrogation signal 131 usually has an amplitude great enough to be detected with high fidelity (e.g., SNR>10 dB) by the readers 120b-120d in listener mode.

The RFID tag location system 100 can also include or interact with handheld readers, vehicle- or cart-mounted readers, or other readers that are not connected to the system controller 110 via a wired connection. These readers may be switchable between interrogator and listener modes. They can also be conventional readers that operate exclusively as interrogators, i.e., by transmitting interrogation signals and receiving tag replies without detecting or processing interrogation signals from other readers. In either case, when a handheld or mobile reader transmits an interrogation signal, the readers that are both in listener mode and within range detect both that interrogation signal and any tag replies. These readers may compute the estimated AOA, range, and/or multipath profile of the tag reply and the location of the responding tag from the tag replies and report the locations, AOA, range, multipath profile, and/or tag reply parameters (e.g., magnitude, phase, time of arrival) to the system controller for more processing.

The stationary listeners can also measure the AOAs, ranges, and/or multipath profiles associated with the handheld or mobile readers based on the received interrogation signals. This can be especially useful if the location of the handheld or mobile reader is not known precisely.

If desired, the handheld reader may broadcast a command to the readers that switches them into listener mode before transmitting the interrogation signal. Alternatively, the readers can scan the RFID channels for handheld readers when not transmitting. Or the readers (including the handheld reader) can use a self-synchronizing PN sequence to drive the frequency hopping such that all readers (fixed and/or handheld) can synchronize to the hopping pattern.

### RFID Tag Reader Architecture

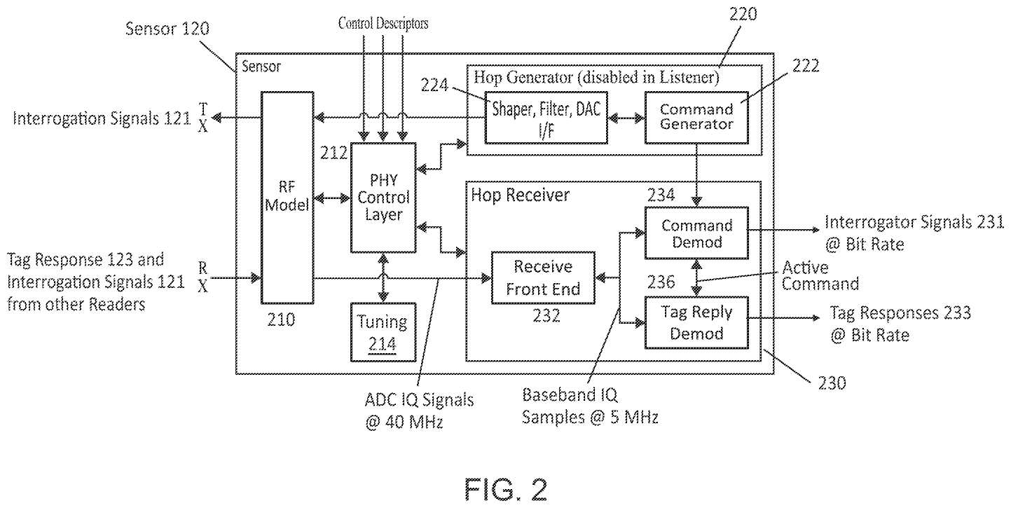

FIG. 2 illustrates the reader 120 in greater detail, including components that can be enabled or disabled if the reader 120 is in interrogator mode or listener mode. The reader 120 includes an RF antenna and front end 210, a processor 212, an RF calibration and tuning block 214, a hop generator 220, and a hop receiver 230. The RF antenna and front end 210 may include one or more antenna elements, amplifiers, filters, and/or other analog RF components for transmitting RFID interrogation signals 121 and receiving tag replies 131 and RFID interrogation signals 121 from other readers. The processor 212 may be implemented in a microcontroller, application-specific integrated circuit (ASIC), field-programmable gate array (FPGA), or other suitable device and controls the operation of the reader 120. It stores information in and retrieves information from a memory (not shown) and communicates with the system controller via a network connection (not shown), such as an Ethernet or WiFi connection. And the processor 212 switches the reader 120 between interrogator and listener modes, with the hop generator 220 being disabled or off in listener mode and enabled or on in interrogator mode and the hop receiver 230 being enabled or on in both modes. The RF calibration and tuning block 214 performs RF calibration and tuning functions.

The hop generator 220 generates the interrogation signals 121 that the reader 120 transmits to the RFID tags 130 and other readers 120 (FIGS. 1A-1C). It may also generate commands or communications signals intended for other readers 120, e.g., on a dedicated reader communications channel or with particular preambles or payloads. It includes a digital command generator 222, which generates the digital queries, commands, and/or other information conveyed by the interrogation signals 121, and RF electronics 224 for turning the digital signals from the command generator 222 into analog signals suitable for transmission by the antenna 210. The RF electronics 224 may include a digital-to-analog converter (DAC) that converts the digital signal into a baseband analog signal, a mixer and local oscillator to mix the baseband analog signal up to an intermediate frequency, and filters and/or pulse shapers to remove sidebands and/or spurs.

The hop receiver 230 includes a receiver front end 232 coupled to a command demodulator 234 and a tag reply demodulator 236. Generally, the receiver front end 232 digitizes, down-converts, and estimates the phase of the RF signals detected by the antenna(s). In interrogator mode, it also cancels any self-interference caused by the interrogation signals 121, for example, due to leakage within the receiver. If the antenna is an antenna array used to transmit and receive, self-interference can also be generated when an antenna element “receives” an interrogation signal emitted by an adjacent antenna element. When the reader 120 is in listener mode, the receiver front end 232 does not transmit an interrogation signal, nor does it perform self-interference cancellation. In listener mode, the reader 120 detects the channels on which the other readers 120 transmit interrogation signals 121 and estimates the frequencies of those other interrogation signals 121.

There are a variety of ways to configure the receiver front end 232; in this example, it receives analog in-phase and quadrature (I/Q) signals at 40 MHz and converts them into digital I/Q samples at baseband (5 MHz) as explained in greater detail below. The command demodulator 234 is enabled when the reader 120 is in listener mode and demodulates the baseband command I/Q samples to produce interrogator signals 231 at the command bit rate (e.g., 40 kbps to 160 kbps). The command demodulator 234 uses the command payload to determine what the reader 120 in interrogator mode is asking of the tag 130 (e.g., modulation, preamble type, expected reply type, etc.). For example, the reader 120 in interrogator mode may ask the tag 130 to send the first 64 bits of its electronic product code (EPC) using Miller-2 modulation at 320 kHz backscatter link frequency (BLF) with the standard preamble. The readers 120 in listener mode use that information to decode the tag reply 131. The command demodulator 234 is disabled when the reader 120 is in interrogator mode. The tag reply demodulator 236 is enabled in both interrogator and listener modes and demodulates the baseband tag reply I/Q samples to produce tag reply signals 233 at the tag reply bit rate.

### Self-Interference Cancellation Circuit for Receiver Front End

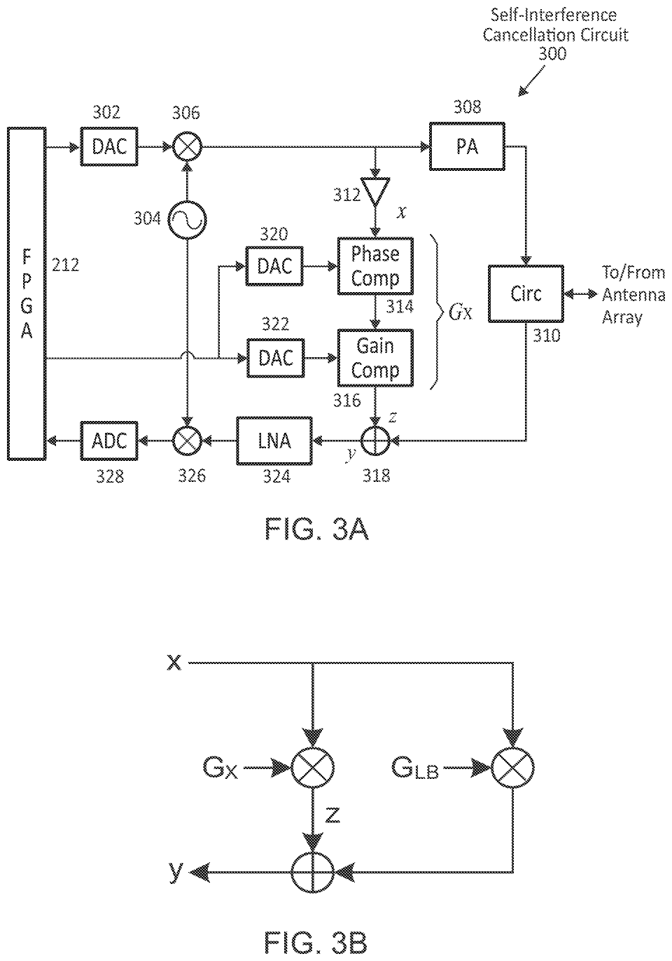

FIG. 3A is a block diagram of a self-cancellation circuit 300 suitable for use in the receiver front end. The control layer 212 (FIG. 2) can be implemented as a field-programmable gate array (FPGA) and is coupled to a digital-to-analog converter (DAC) 302 that converts digital commands at baseband from the hop generator 220 into analog commands at baseband. A first mixer 306 coupled to the DAC 302 and to a local oscillator (LO) 304 mixes the analog commands at baseband up to the relevant RFID communication band (e.g., 902 to 928 MHz in the United States or 865 to 868 MHz in Europe). A fraction of the mixer output is tapped into a cancellation path with a complex gain Gₓ, and the rest is amplified by a power amplifier 308 coupled to a three-port circulator 310, which sends the amplified command to the antenna array (not shown) and receives the signal collected by the antenna array. Alternatively, the power amplifier 308 can be located between the mixer output and the tap point for the cancellation path such that it amplifies the mixer output and a portion of its output is tapped into the cancellation path.

Self-interference can come from a variety of sources. When operating in interrogator mode, a portion of the transmitted signal can leak from the first port to the third port of the circulator 310. Another portion of the transmitted signal can reflect off the antenna back into the circulator 310 instead of being transmitted by antenna. Power transmitted by one antenna element can be detected and coupled back into the receiver by other antenna elements, generating crosstalk between antenna elements. In some cases, the circulator provides 15-25 dB of isolation, but crosstalk could reduce the effective isolation to about 11 dB. Moreover, the crosstalk and isolation vary as a function of the beam-steering angle; beam-steering changes the phase difference between signals transmitted by adjacent antennas, which in turn changes the coupling between adjacent antenna elements. Together, this unwanted leakage, reflected power, and crosstalk can create a strong loopback signal into the receiver which may drown out any tag replies, which tend to be relatively weak. (Receiver noise and unwanted backscatter may also obscure tag replies.)

The cancellation circuit 300 attempts to subtract this loopback signal from the received signal. To do this, it generates a cancellation signal by amplifying, phase-shifting, and/or attenuating the portion of the command tapped off from the output of the first mixer 306 with an amplifier 312, a programmable phase shifter (phase compensator) 314, and a programmable attenuator (gain compensator) 316. The programmable attenuator 316 can be implemented as a set of concatenated programmable attenuators with identical or different values for finer control. In this example, the programmable phase shifter 314 is before the programmable attenuator 316, but the programmable attenuator 316 can be before the programmable phase shifter 314 instead or the programmable phase shifter 314 can be between different programmable attenuators 316. The programmable phase shifter 314 and programmable attenuator 316 are controlled by the FPGA 212 via respective DACs 320 and 322 as described below. A power combiner 318 combines the cancellation signal with the raw signal from the antenna array to produce a processed signal from which self-interference has been largely canceled.

This signal is amplified with a low-noise amplifier (LNA) 324, then mixed to baseband with a second mixer 326 and digitized with an analog-to-digital converter (ADC) 328 that is coupled to the FPGA 212. The LNA 324 provides the receiver gain and can be set to a lower gain (e.g., based on the ADC 328 dynamic range as discussed below) for initial calibration of the self-interference cancellation circuit and to a higher gain for normal hops and for maintenance calibration of the self-interference cancellation circuit. In practice, the LNA 324 can operate in an enabled or bypass mode and coupled in series to a fine-gain programmable gain block that allows for many small gain adjustments (e.g., about 40 gain adjustments of 1 dB each).

The amplitude of the transmitted signal can be up to 90 dB greater than the amplitude of the received tag reply. A very good circulator can reduce leakage into the receiver by 25 dB, implying a residual spread between the leakage and the received tag reply of about 65 dB. Thus, to avoid saturating the ADC 328, the ADC 328 should have roughly 65 dB or about 10 more bits of headroom without self-interference cancellation than with perfect self-interference cancellation.

With the correct gain and phase settings, the cancellation circuit 300 cancels or suppresses the leakage from the transmitted signal. The gain and phase settings are calibrated or estimated by transmitting and canceling a low-power continuous-wave (CW) calibration signal twice with two separate sets of settings for the phase compensator 314 and gain compensator 316, measuring the received power at the ADC 328, and using the measured power at each set of gain and phase setting to derive estimates of the gain and phase. The power level of this low-power CW calibration signal is selected to prevent saturating the ADC 328. This calibration process can be repeated until the gain and phase settings converge to values that sufficiently suppress the transmit signal appearing at the ADC 328; at low power levels for the calibration signal, the calibration process can converge in as few as two measurements.

Generally, the transmitted signal is sufficiently suppressed when it does not saturate the ADC 328, even in the presence of a tag reply. (Recall that a tag alternates between absorbing and reflecting the CW radiation from the reader and thus, when reflecting power, it may boost the received signal power above the power received during calibration.) Better self-interference cancellation reduces ADC headroom or dynamic range required for the tag reply as the ratio of tag reply power to the suppressed CW power becomes larger.

To understand why the ADC headroom increases, consider what happens if the self-interference cancellation is perfect, leaving only the tag reply at the receiver. In this case, the ratio of the tag reply power to CW power is infinite, so the tag reply plus any receiver gain dictates the dynamic range of the ADC 328. Thus, the self-cancellation circuit should cancel enough leakage power to prevent the strongest possible amplified tag signal plus any uncancelled leakage power from saturating the ADC 328. If the self-cancellation circuit cancels 20 dB of self-interference, then the gain can go up by almost 20 dB because the amplified tag reply is still only a fraction of the input to the ADC 328. If self-cancellation circuit cancels 50 dB of self-interference, on the other hand, then the amplified tag reply dominates the input to the ADC 328, which is the desired operating condition-ideally, the only signal input to the ADC 328 is the tag reply.

### Self-Interference Cancellation Circuit Operation

FIG. 3B shows a model of how the cancellation circuit 300 performs self-interference cancellation. The input x represents a command generated by the hop generator 220, the output y represents the signal returned by the cancellation circuit 300 to the hop receiver 230, and z is the cancellation signal generated by self-interference cancellation circuit 300. The input x is divided into two paths, each of which alters the signal amplitude. The right-hand path represents the loopback or reflected path and has a complex loopback gain represented as G_{LB}. The left-hand path or cancellation path has a complex cancellation gain Gₓ (also called the complex gain of the self-interference cancellation circuit) that can be set or calibrated to offset or cancel the complex loopback. In the absence of the tag reply, combining the outputs of the signal and cancellation paths yields the output y:

y=x(G_{X}+G_{LB})

If the cancellation is perfect (i.e., if Gₓ=−G_{LB}), then y=0 in the absence of the tag reply. In other words, the complex cancellation gain Gₓ perfectly matches the loopback gain G_{LB}, so the cancellation circuit 300 perfectly cancels the leakage through the circulator 310, the reflections from the antenna connectors, and the leakage across antenna elements and then the local reflectors (including the tags) that reflect the CW signal back to the reader. If the tag replies, it does so by changing how it reflects (it toggles from primarily absorbing CW radiation to primarily reflecting CW radiation), so the reader selects and calibrates the complex cancellation gain when the tags are not replying.

By way of non-limiting example, consider a power amplifier output of 30 dBm, which is the FCC limit on the total power emitted by antenna array. For an antenna array with four antenna elements, this translates to 24 dBm per antenna element. If the power amplifier provides 15 dB of gain, then the input power is x=15 dBm, or 9 dBm per antenna element for four antenna elements. In the model above, the complex loopback gain G_{LB} includes the gain from the power amplifier plus loss from the circulator and leakage and return loss of the antenna element. If the circulator provides 15 dB of isolation, then the complex loopback gain G_{LB} is 0 dB. The power of the cancellation signal z should match the input power x amplified by the complex loopback gain G_{LB}, i.e., z=x+G_{LB}=15 dBm+0 dB (9 dBm+0 dB per antenna element for four antenna elements). The difference between x and z is the complex cancellation gain Gₓ, which in this case is 0 dB.

During calibration, the receiver reuses or repurposes a portion of its frequency estimation logic (described below) to measure y (e.g., by integrating 120 5 MHz samples of the initial CW portion of a hop as described below) and to derive the complex cancellation gain from y. The gain portion of the complex cancellation gain provides the setting for the programmable attenuator 316, and the phase portion provides the setting for the programmable phase shifter 314. In practice, changing the programmable attenuator setting introduces a small phase shift, and changing the programmable phase shifter setting changes the attenuation. Proper calibration involves iterating over the possible attenuations and phase shifts to arrive at the desired complex cancellation gain.

If the cancellation circuit is not operating in saturation, it can converge to the desired complex cancellation gain in two to twenty iterations. If y is measured twice, the first time with a complex gain G_{X,1} and the second time with a complex gain G_{X,2}, it yields two different outputs:

$${y}_{1} = {x}_{1} ( {G}_{X , 1} + {G}_{LB} ) \\ {y}_{2} = {x}_{2} ( {G}_{X , 2} + {G}_{LB} )$$

Because this is a loopback signal where the transmitter and receiver share a common frequency reference and the CW portion of the signal is constant over the entire calibration period, the phase and frequency are locked, so x₁=x₂=x. This leaves two equations and two unknowns: x and G_{LB}. Using simple algebra, the two unknowns can be computed as follows:

$$x = \frac{{y}_{2} - {y}_{1}}{{G}_{X , 2} - {G}_{X , 1}} and {G}_{LB} = \frac{{y}_{1} {G}_{X , 2} - {y}_{2} {G}_{X , 1}}{{y}_{2} - {y}_{1}}$$

From the model in FIG. 3B and the equations above, perfect cancellation occurs when Gₓ=−G_{LB}. Thus, from both measurements, the desired gain to achieve perfect cancellation is:

$${G}_{X} = \frac{{y}_{2} {G}_{X , 1} - {y}_{1} {G}_{X , 2}}{{y}_{2} - {y}_{1}}$$

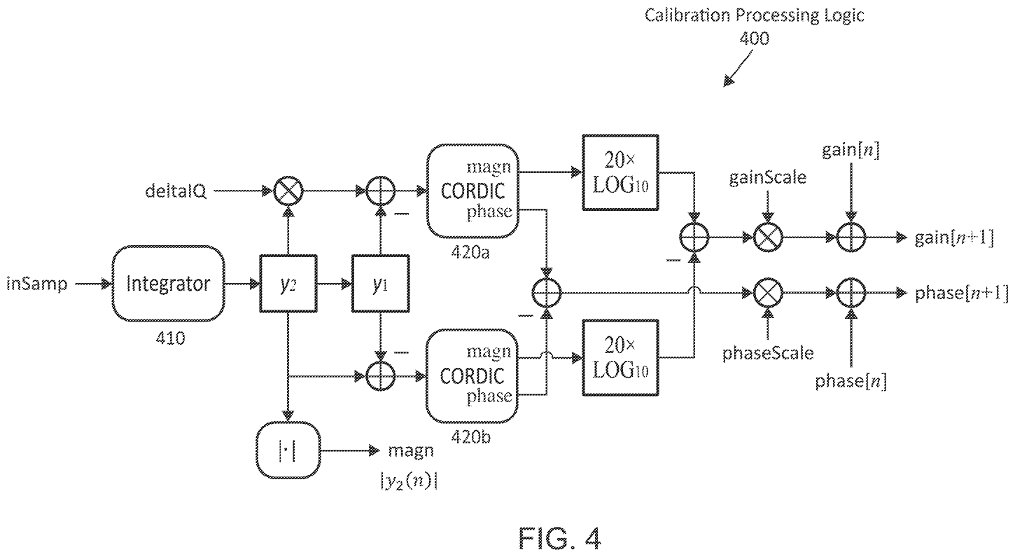

If the complex loopback gain varies in a perfectly linear fashion, a processor or processing logic (e.g., as shown in FIG. 4 and described below) can estimate the cancellation gain by selecting two different gains for gain G_{X,1} and G_{X,2} and then obtaining measurements of the corresponding received signals y₁ and y₂. In practice, non-linearities in the RF gain and phase compensators as well as potential received signal saturation at the ADC 328 mean that repeating this measurement process multiple times leads to more precise estimation of the desired gain. The processing logic can speed up convergence to an acceptable gain estimate using the last best-known cancellation gain. On a practical level, the processing logic can set G_{X,2} to the best guess (and G_{X,1} offset from that) such that if the transmitted signal is still sufficiently suppressed given G_{X,2}, then an adjustment to G_{X} is not required. In that case, however, G_{X} becomes the best guess for the next hop.

The processing logic writes the cancellation gains to the cancellation DACs 320 and 322 in units of decibels and degrees and the yₓ terms are complex in-phase (I) and quadrature (Q) values. Computing the desired cancellation gain G_{X} therefore involves conversions from decibels to linear amplitudes, polar to rectangular coordinates, division, and then conversion back to polar coordinates and decibels. These are very costly operations in the register transfer level (RTL).

Fortunately, the processing logic can be greatly simplified at the cost of increasing the number of measurements (e.g., from N+1 to 2N where N is the number of iterations; the expected value for N in steady state is 2). To start, define a fixed complex gain offset G_{Δ} such that G_{X,1}=G_{Δ}G_{X,2}. This gain offset is stored in the RTL in complex (IQ) format. The complex cancellation gain becomes (adding the index n for iteration count):

$${G}_{X} ( n + 1 ) = {G}_{X} ( n ) \frac{{y}_{2} ( n ) {G}_{Δ} - {y}_{1} ( n )}{{y}_{2} ( n ) - {y}_{1} ( n )} ,$$

where the numerator and denominator computations are more straightforward complex numeric operations. Next, define the numerator term as A_{N}(n)e^{jθ}^{_{N}}⁽ⁿ⁾=y₂(n)G_{Δ}−y₁(n) and the denominator term as A_{D}(n)e^{jθ}^{_{D}}⁽ⁿ⁾=y₂(n)−y₁(n). The conversion from complex to polar can be performed by the same COordinate Rotation DIgital Computer (CORDIC) that the receiver uses to estimate the interrogation signal frequency and phase in listener mode. The equation for the complex cancellation gain becomes:

$$\begin{matrix}{G}_{X} ( n + 1 ) = {G}_{X} ( n ) \frac{{A}_{N} ( n )}{{A}_{D} ( n )} {e}^{j ( {θ}_{N} ( n ) - {θ}_{D} ( n ) )} \\ = {G}_{X} ( n ) \times {\overbrace{{10}^{( 20 {log}_{10} {A}_{N} ( n ) - 20 {log}_{10} {A}_{D} ( n ) )} {e}^{j ( {θ}_{N} ( n ) - {θ}_{D} ( n ) )}}}^{gain adjustment}\end{matrix} ,$$

which includes the current cancellation gain G_{X}(n) and an adjustment term. The 20 log₁₀ A terms can be computed in RTL fairly cost effectively using a shifter and lookup table.

Finally, because the cancellation DACs 320 and 322 consume the complex cancellation gain G_{X}(n) in decibels and degrees, the complex gain adjustment should be in terms of decibels and degrees too. Fortunately, that simplifies the computations for gain and phase to:

$${\vert {G}_{X} ( n + 1 ) \vert}_{dB} = {\vert {G}_{X} ( n ) \vert}_{dB} + ( 20 {log}_{10} {A}_{N} ( n ) - 20 {log}_{10} {A}_{D} ( n ) ) \\ ∠ {{G}_{X} ( n + 1 )}_{deg} = ∠ {{G}_{X} ( n )}_{deg} + \frac{360}{2 π} ( {θ}_{N} ( n ) - {θ}_{D} ( n ) )$$

These results of these equations are the settings, in decibels and degrees, for the gain compensator 316 and phase compensator 314, respectively, in FIG. 3A.

The analysis above applies to the complex cancellation gain for a single stream. For a reader with a multi-element antenna array, there can be up to one transmit stream and one receive stream per antenna element. With multiple transmit and receive streams, the transmit streams can generate crosstalk into the other streams. This crosstalk occurs when one antenna element receives a transmission directly from another antenna element as well as reflected (e.g., multipath) transmissions from other antenna elements.

To analyze this crosstalk, consider two streams, each with a unique amplitude and phase, from a pair of antenna elements. Each antenna element transmits at the same frequency. Of interest is the sum of these two streams, with the second resulting in crosstalk into the first:

$$x ( t ) = {A}_{1} sin ( ω t ) + {A}_{2} sin ( ω t + θ ) ,$$

where A₁ and A₂ are the amplitudes of the first and second streams, respectively, and θ is the phase difference between the first and second streams. This sum can be expressed as a sine wave with the same frequency but a different amplitude and phase:

x(t)=A_{XT} sin(ωt+θ_{XT}),

where A_{XT}=\sqrt{A₁²+A₂²+2A₁A₂ cos θ} and θ_{XT}=atan2 (sin θ_{XT}, cos θ_{XT}), and where sin θ_{XT}=(A₂ sin θ)/A_{XT} and cos θ_{XT}=(A₁+A₂ cos θ)/A_{XT}. (The function atan2 (y, x)=atan (y/x) is defined as the angle in the Euclidean plane between the positive x axis and the ray from the origin to the point x, y, or, equivalently, the phase or angle of the complex number x+iy.) Thus, the crosstalk shifts the amplitude and phase of the first stream but does not change the first stream's frequency. Because the crosstalk does not alter the sinusoidal nature of the signal to be canceled, the cancellation circuit 210 can cancel crosstalk too.

FIG. 4 illustrates the processing logic 400 in the reader used to set and calibrate the complex cancellation gain. This processing logic 400 includes an integrator 410 and two CORDICs 420a and 420b that can be used to estimate hop frequency when the reader is in listener mode. The integrator 410 acts a filter that generates the measurements y₁ and y₂ from the raw input signal. More specifically, the number of samples integrated by the integrator 410 corresponds to an integer number of carrier cycles for the adjacent channels (or at least the channels that fall within the filtered tag reply bandwidth). In other words, the number of samples integrated by the integrator 410 is picked to cancel the transmitted signal and to remove potential interferers in adjacent channels so that they don't interfere with self-interference cancellation. For estimating the cancellation gain, the window size (number of sample) can be any length, with larger windows (more samples) providing more averaging at the cost of more time for calibration.

In the industrial, scientific, and medical (ISM) band, for example, there may be channels at 500 kHz, 1 MHZ, 1.5 MHz, and so on. If the desired low-pass filter bandwidth is 2.5 MHz, the number of samples per sinewave cycle is fₛ/f_{ch}=5 MHz/500 kHz=10 for the first adjacent channel at 500 kHz, 5 MHz/1 MHZ=5 for the second adjacent channel at 1 MHz, 10/3 for the 1.5 MHz adjacent channel, 5/2 for the 2 MHz adjacent channel, and 2 for the 2.5 MHz adjacent channel. Thus, the integration window size W should be selected such that W×[10, 5, 10/3, 5/2, 2] results in an all-integer array (implying an integer number within the window size). In this case, if W=30, then there will be 30×[10, 5, 10/3, 5/2, 2]=[300, 150, 100, 75, 60] cycles of the channels within the 30-sample integration window. In this case, then, integrating over 30 samples cancels the adjacent channels (i.e., the sum of all samples within a single period of a sinewave is 0). Increasing the number of samples, e.g., to an integer multiple of 30 like 60 or 120 samples, provides additional noise averaging.

The signals are weighted and combined, then fed into the CORDICs 420a and 420b. (CORDICs 420 are well suited to implementation in an FPGA and other types of processing logic 400.) The upper CORDIC 420a calculates the magnitude and phase of y₂(n)G_{Δ}−y₁(n), and the lower CORDIC 420b calculates the magnitude and phase of y₂(n)−y₁(n). Instead of two CORDICs 420, a single CORDIC can compute, in series, the magnitude and phase of y₂(n)G_{Δ}−y₁(n) and the magnitude and phase of the difference between the measurements y₂(n)−y₁(n). Serial computations reduce the amount of logic (hardware) and are feasible because the magnitude and phase calculations are not particularly time constrained. Alternatively, the processing logic 400 can compute the magnitudes and phases using other techniques (e.g., based on the in-phase and quadrature components of the signals). The phases are combined and scaled to produce the estimated phase cancellation setting for the phase compensator 314 (FIG. 3A), and the magnitudes are combined and scaled to produce the estimated gain cancellation setting for the gain compensator 316 (FIG. 3A).

The complex scalar G_{Δ} (deltaIQ in FIG. 4) is the change in gain between the two guesses or estimates of the complex cancellation gain. If these guesses are too far apart, then nonlinearities can degrade the result (i.e., if the gain varies nonlinearly, then a linear interpolation or extrapolation will deviate from the actual gain). If those guesses are too close together, then noise may cause the measurements to change more than any measured change. In other words, the scaling G_{Δ} should be as small as possible to avoid nonlinearities in the phase compensator 314 and gain compensator 316 but large enough to reduce or avoid the impact of noise. If the gain compensator 316 has a dynamic range of 40 dB, the gain scaling can be on the order of 0.1 dB. Similarly, the phase compensator 314 has a dynamic range of about 360° with a phase scaling whose resolution can be as fine as 1.0° (finer phase scaling resolution, e.g., of order 0.1°, is also possible).

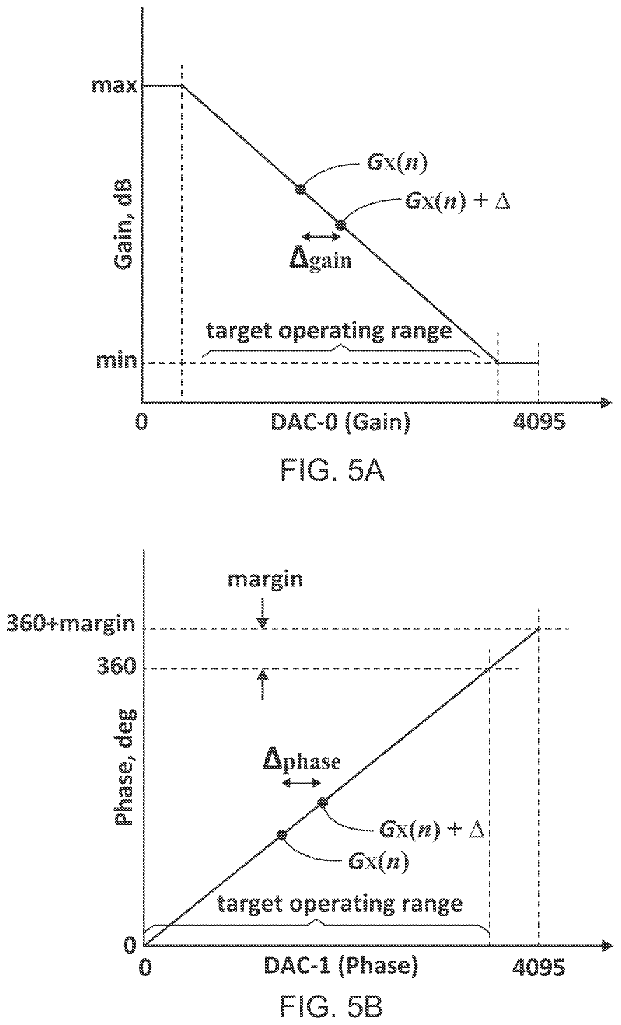

FIGS. 5A and 5B show modeled responses of the DACs 322 and 320 (FIG. 3A), respectively, that set the gain and phase scalings (gainScale and phaseScale in FIG. 4) for the combined CORDIC magnitude and phase outputs. (In practice, the responses of the DACs 322 and 320 may not be perfectly linear or even piecewise linear.) FIG. 5A reflects the slope of the gain curve within the operating range multiplied by the 20 log₁₀ 2 that converts the log₂ estimates into 20 log₁₀ estimates. FIG. 5B shows the slope of the phase curve. For better performance, the cancellation circuit should operate in the non-saturated region of the gain curve and in the lowest 360° portion of the phase curve to avoid discontinuities due to phase wrapping.

The changes in gain and phase with each iteration are summed to the best guess for complex cancellation gain Gx(n). For the gain curve, this ensures that if the self-interference (leakage signal) is very strong, the sum Gx(n)+Δ_{gain} will not fall into the left-most nonlinear region of the gain curve in FIG. 5A, thus increasing the likelihood that the TXC calibration will converge. This does mean that G_{X}(n)+Δ_{gain} could fall into the right-most nonlinear region of the gain curve if the self-interference is very weak; but if the self-interference signal is weak, that is less consequential. Similarly, the phase can be confined to the range 0° to 360°+Δₚₕₐₛₑ, where Δₚₕₐₛₑ is the change in phase. Provided that the phase change is less than or equal to the margin in FIG. 5B, phase wrapping should not occur, so there should not be any phase discontinuity due to phase wrapping. This does imply that the phase of the best guess Gx(n) should be wrapped at 360° (or the DAC-1 setting wrapped at the DAC setting corresponding to) 360°.

Generally, the changes in gain and phase should be large enough to prevent noise from dominating the term y₂(n)−y₁(n) and small enough such that the differential nonlinearity of the curves is negligible. Differential nonlinearity (DNL) is the error between the expected gain/phase difference between any two points separated by the gain or phase change and the actual gain/phase difference. Ripples will exist in the gain/phase responses creating DNL and thus the gain and phase changes should be selected such that the error due to these ripples will have negligible effect on the calibration results.

The processing logic 400 also calculates the magnitude of the second measurement, |y₂(n)|, to determine if the TX Compensation has converged. It computes this magnitude for each stream (antenna element) and stops iterating over the gain and phase when either (a) the magnitude of each stream drops below a threshold (e.g., |y₂(n)|²) or (b) the reader reaches a predetermined number of iterations.

The cancellation circuit 300 can operate with two self-calibration modes: initial calibration and maintenance calibration. During initial calibration, the desired complex cancellation gain is unknown to start, and thus there may be 100% leakage into to the ADC 328. To avoid saturating the ADC 328, the receiver gain should be relatively low to start. Once the cancellation circuit 300 has completed at least some level of calibration (e.g., as described above), the receiver gain can be increased, e.g., to the desired gain, and the calibration can be repeated (with higher gain, the cancellation can be better) for improved performance. Maintenance calibration occurs during operation, with the calibration circuit 300 set to the desired/higher complex cancellation gain, to track and compensate for drifts in the leakage signal power over time. Maintenance calibration occurs at the beginning of a hop and can take place during every hop

As an example, consider a threshold for residual CW signal to be half of the ADC's full scale when the receiver is at the normal operating gain setting for receiving tag replies. The cancellation circuit 300 performs initial calibration with an initial receiver gain Gᵢₙᵢₜᵢₐₗ low enough to avoid saturation, assuming no cancellation. (The receiver gain is the gain applied to the tag reply by the receiver, e.g., by the LNA 324 or another amplifier between the power combiner 318 and the ADC 324, after the transmit cancellation signal has been cancelled out.) Thus, the first target threshold should be 0.5/10^{G}^{ᵢₙᵢₜᵢₐₗ}^{/20}. For example, if the normal receiver gain is 20 dB below Gᵢₙᵢₜᵢₐₗ, then the initial self-interference cancellation should suppress the CW signal to <0.5/10=1/20th of the ADC dynamic range. If the cancellation circuit 300 achieves this level of self-interference cancellation, then increasing the receiver gain to the desired operating gain increases the amplitude of the residual CW signal, but to less than half of the ADC's dynamic range. Once the receiver gain has been set, the cancellation circuit 300 can run maintenance calibrations at the start of every hop at the target receiver gain for that hop.

### Hops and Self-Cancellation Calibration

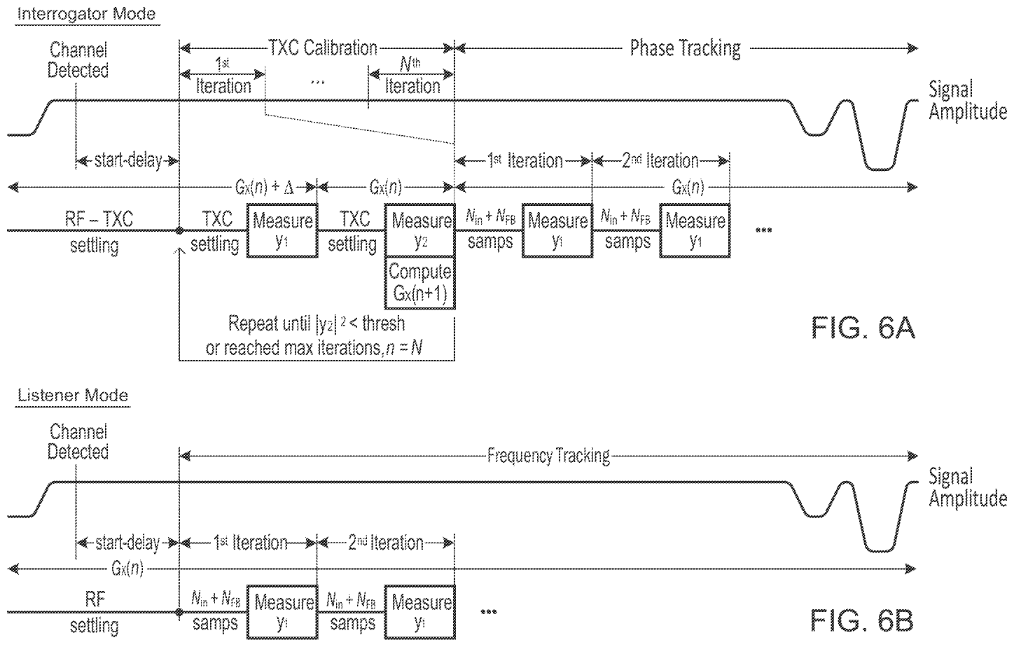

FIGS. 6A and 6B illustrate transmitted signals and timelines for hops (transmissions and the tag replies) for readers in interrogator mode and listener mode, respectively. Start delay is common to both interrogator and listener modes. This delay allows for any transients related to turning on the reader's RF components to settle before calibration begins. Generally, the start delay should be a small fraction of the 1.5 msec CW period at the start of each hop, for example, 0.1 msec.

In interrogator mode, shown in FIG. 6A, the cancellation circuit 300 calibrates itself at the start of each hop (transmission) and prior to modulating commands to compensate for variations in the pre-amplifier 308 due to temperature and aging as well as to account for channel variations. In FIG. 6A, the reader transmits a CW tone as part of the start of the hop for a transmitter cancellation (TXC) calibration period, during which the reader “charges” the RFID tag. Eventually, the reader modulates the amplitude of the CW tone to produce an interrogation signal. The interrogator can pause command transmission during a hop at any time to re-tune the transmitter cancellation should it drift out of range.

During the TXC calibration period, the reader makes two measurements at different complex cancellation gain settings: y₁(n) for the first complex cancellation gain G_{X}(n)+Δ, and y₂(n) for the second complex cancellation gain G_{X}(n), which is a best guess. After the second measurement, the reader computes a new complex cancellation gain G_{X}(n+1). If the error associated with complex cancellation gain is below a predetermined threshold (e.g., |y₂(n)|²), then the reader continues using G_{X}(n) as the complex cancellation gain. Otherwise, the reader repeats the measurements and calculations with the new complex cancellation gain G_{X}(n+1) as the initial guess. The reader can repeat this process until the error falls below the threshold or the reader reaches the maximum number of allowed iterations.

The transmit power does not change as a function of TXC convergence and may be set to maximum power. Rather, the reader varies the low-noise amplifier (LNA) gain during calibration depending on whether or not the reader has an initial guess for the TXC settings to avoid saturation. The reader can change the LNA settings from a low-gain setting to a high-gain setting once TXC has converged, then calibrate the TXC again to ensure that the change in LNA gain has not altered the settings. For example, if the LNA gain increases by 20 dB to amplify a weak RFID tag reply, then during initial calibration, the cancelled interference signal should be at least 20 dB below the saturation level. During maintenance calibration, because the LNA gain is already set, the reader should cancel the interference enough to prevent saturating the ADC while leaving enough headroom to account for the RFID tag signal itself.

Once TXC calibration ends, the reader begins receiving, integrating, and processing signals received by the antenna. It integrates N samples during each integration period, with a dead time of Nᵢₙ+N_{FB} sample periods between integrations, where Nᵢₙ sample periods account for the filter settling time and N_{FB} sample periods account for the time to compute the phase estimates from the integrated samples. The start-delay before TXC calibration represents the number of samples that are discarded before the first iteration of either TXC calibration or frequency tracking.

In listener mode, shown in FIG. 6B, self-interference cancellation is disabled and thus the reader does not perform TXC calibration. Instead, it estimates and tracks the frequency and phase of the hop. (In interrogator mode, the sensor is transmitting so there is only phase tracking; in listener mode, the sensor is not transmitting and thus performs frequency and phase tracking). In interrogator mode, TXC cancellation should be completed prior to starting phase tracking because the sensor estimates the phase of the residual CW signal. Given this phase estimate, it is possible to subtract out any residual CW signal digitally. Alternatively, the sensor can skip phase estimation and use a notch filter to filter out any residual CW signal.

In listener mode, the sensor does not transmit, so it does not need to perform RF TXC. But the sensor should still: (a) decode the commands from the sensor in interrogator mode so that it can decode the resultant tag replies; (b) track the frequency/phase drift of the CW signal as that effectively tracks the frequency phase of the tag reply signal (which is modulated, reflected CW radiation); and (c) remove the CW signal to reduce the dynamic range into the tag demodulator. The sensor performs frequency/phase tracking on a continual basis, where it waits for previous frequency/phase estimates to be applied and then estimates a new frequency/phase estimate. FIG. 6B shows this frequency/phase tracking as 1st and 2nd iterations, with each iteration beginning with a sampling period followed by a measurement period. As in phase tracking during in interrogator mode, the sensor integrates N samples during each integration period, with a dead time of Nᵢₙ+N_{FB} sample periods between integrations. The iterations can be repeated until the end of the hop.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A radio-frequency identification (RFID) tag reader comprising:
a signal generator to generate an interrogation signal;
an antenna to transmit the interrogation signal to an RFID tag and to receive a reply to the interrogation signal from the RFID tag;
a circulator having a first port operably coupled to the signal generator to receive the interrogation signal, a second port operably coupled to the antenna to couple the interrogation signal to the antenna and to receive the reply from the antenna, and a third port to emit the reply to the interrogation signal;
a self-interference cancellation circuit, operably coupled to the signal generator and the third port of the circulator, to cancel interference caused by (i) leakage of the interrogation signal from the first port of the circulator to the third port of the circulator and/or (ii) crosstalk between antenna elements in the antenna by amplifying a portion of the interrogation signal by a complex gain and adding the portion of the interrogation signal to the reply to the interrogation signal; and
a processor, operably coupled to the self-interference cancellation circuit, to calibrate a complex gain of the self-interference circuit.

2. The RFID tag reader of claim 1, wherein the processor is configured to calibrate the complex gain by:
performing a measurement y₁(n) of self-interference cancellation by the self-interference cancellation circuit at a first complex gain setting G_{X}(n);
performing a measurement y₂(n) of self-interference cancellation by the self-interference cancellation circuit at a second complex gain setting G_{X}(n)G_{Δ}; and
adjusting the complex gain based on the measurement y₁(n), the first complex gain setting G_{X}(n), the measurement y₂(n), and the second complex gain setting G_{X}(n)G_{Δ}.

3. The RFID tag reader of claim 2, wherein the processor comprises:
an integrator to perform the measurement y₁(n) and the measurement y₂(n);
at least one COordinate Rotation DIgital Computer (CORDIC), operably coupled to the integrator, to compute a magnitude and a phase of y₂(n)G_{Δ}−y₁(n) and to compute a magnitude and a phase of y₂(n)−y₁(n).

4. The RFID tag reader of claim 3, wherein the integrator is configured to perform the measurement y₁(n) and the measurement y₂(n) by acquiring a number of cycles equal to an integer multiple of a number of cycles of carrier frequency of the interrogation signal.

5. The RFID tag reader of claim 4, wherein the number of cycles is equal to an integer multiple of a number of cycles of a carrier frequency of a channel adjacent to a channel of the interrogation signal.

6. The RFID tag reader of claim 1, wherein the processor is configured to calibrate the self-interference cancellation circuit at a beginning of each transmission by the antenna to the RFID tag.

7. The RFID tag reader of claim 1, wherein the self-interference circuit comprises:
an adjustable phase compensator to provide a phase component of the complex gain;
a first digital-to-analog converter (DAC), operably coupled to the adjustable phase compensator and the processor, to adjust the phase component of the complex gain based on feedback from the processor;
an adjustable gain compensator to provide a gain component of the complex gain; and
a second DAC, operably coupled to the adjustable gain compensator and the processor, to adjust the gain component of the complex gain based on feedback from the processor.

8. The RFID tag reader of claim 1, wherein:
the RFID tag reader is configured to be switched between an interrogator mode in which the RFID tag reader transmits interrogation signals and receives replies to the interrogation signals and a listener mode in which the RFID tag reader receives interrogation signals from other RFID tag readers and replies to the interrogation signals from the other RFID tag readers.

9. The RFID tag reader of claim 8, wherein the self-interference cancellation circuit is disabled when the RFID tag reader is in listener mode.

10. A method of interrogating a radio-frequency identification (RFID) tag with an RFID tag reader comprising a self-interference cancellation circuit, the method comprising:
generating a continuous wave (CW) signal with the RFID tag reader;
calibrating a complex cancellation gain of the self-interference cancellation circuit based on iterative measurements of self-interference cancellation of the CW signal at a first receiver gain level;
after calibrating the complex cancellation gain, transmitting an interrogation signal to the RFID tag;
receiving a reply to the interrogation signal from the RFID tag at a second receiver gain level higher than the first receiver gain level; and
cancelling self-interference from the reply with the self-interference cancellation circuit.

11. The method of claim 10, wherein calibrating the complex cancellation gain comprises:
performing a measurement y₁(n) of self-interference cancellation by the self-interference cancellation circuit at a first complex gain setting G_{X}(n) of the self-interference cancellation circuit;
performing a measurement y₂(n) of self-interference cancellation by the self-interference cancellation circuit at a second complex gain setting G_{X}(n)G_{Δ} of the self-interference cancellation circuit; and
adjusting the complex cancellation gain of the self-interference cancellation circuit based on the measurement y₁(n), the first complex gain setting G_{X}(n), the measurement y₂(n), and the second complex gain setting G_{X}(n)G_{Δ}.

12. The method of claim 11, wherein adjusting the complex cancellation gain comprises:
computing a magnitude and a phase of y₂(n)G_{Δ}−y₁(n); and
computing a magnitude and a phase of y₂(n)−y₁(n).

13. The method of claim 11, wherein performing the measurement y₁(n) comprises acquiring a number of cycles equal to an integer multiple of a number of cycles of a carrier frequency of the interrogation signal.

14. The method of claim 13, wherein the number of cycles is equal to an integer multiple of a number of cycles of a carrier frequency of a channel adjacent to a channel of the interrogation signal.

15. The method of claim 10, wherein calibrating the complex cancellation gain comprises:
adjusting a phase component of the complex cancellation gain with an adjustable phase compensator; and
adjusting a gain component of the complex cancellation gain with an adjustable gain compensator.

16. The method of claim 10, wherein the RFID tag reader is configured to be switched between an interrogator mode in which the RFID tag reader transmits interrogation signals and receives replies to the interrogation signals and a listener mode in which the RFID tag reader receives interrogation signals from other RFID tag readers and replies to the interrogation signals from the other RFID tag readers, and further comprising:
disabling the self-interference cancellation circuit when the RFID tag reader is in listener mode.

17. A method of calibrating a radio-frequency identification (RFID) tag reader, the method comprising:
performing a first measurement of self-interference cancellation by a self-interference cancellation circuit of the RFID tag reader at a first complex gain of the self-interference cancellation circuit;
performing a second measurement of self-interference cancellation by a self-interference cancellation circuit of the RFID tag reader at a second complex gain of the self-interference cancellation circuit different than the first complex gain;
adjusting a complex gain of the self-interference cancellation circuit based on the first measurement, the first complex gain, the second measurement, and the second complex gain.

18. The method of claim 17, wherein performing the first measurement comprises selecting the first complex gain based on a dynamic range of an analog-to-digital converter (ADC) of the RFID tag reader.

19. The method of claim 17, wherein the second complex gain is greater than the first complex gain.

20. The method of claim 17, further comprising, after adjusting the complex gain:
interrogating an RFID tag with the RFID tag reader.

21. The method of claim 20, wherein interrogating the RFID tag comprises:
transmitting, by the RFID tag reader, a continuous-wave (CW) signal to the RFID tag;
while transmitting the CW signal, re-calibrating the complex gain of the self-interference cancellation circuit;
after re-calibrating the complex gain, transmitting, by the RFID tag reader, a signal to RFID tag;
receiving, by the RFID tag reader, a reply from the RFID tag to the signal from the RFID tag reader; and
cancelling self-interference from the reply with the self-interference cancellation circuit.

22. The method of claim 21, wherein re-calibrating the complex gain of the self-interference cancellation circuit comprises:
performing a pair of measurements of the self-interference cancellation by the self-interference cancellation circuit; and
adjusting the complex gain based on the pair of measurements.

23. The method of claim 22, wherein performing the pair of measurements comprises suppressing interference from channels adjacent to a channel of the signal transmitted by the RFID tag reader to the RFID tag.
